(19) United States
(12) Patent Application Publication
(10) Pub. No.: US 2019/0265841 A1
(43) Pub. Date: Aug. 29, 2019

(54) 3D TOUCH INTERACTION DEVICE, TOUCH INTERACTION METHOD THEREOF, AND DISPLAY DEVICE

(71) Applicant: BOE TECHNOLOGY GROUP CO., LTD., Beijing (CN)

(72) Inventors: Chih-Jen CHENG, Beijing (CN); Haisheng WANG, Beijing (CN); Chun Wei WU, Beijing (CN); Xiaoliang DING, Beijing (CN); Yanling HAN, Beijing (CN); Yuzhen GUO, Beijing (CN); Yingming LIU, Beijing (CN)

(73) Assignee: BOE TECHNOLOGY GROUP CO., LTD., Beijing (CN)

(21) Appl. No.: 15/775,978

(22) PCT Filed: Sep. 26, 2017
(86) PCT No.: PCT/CN2017/103456

§ 371 Date: May 14, 2018

(30) Foreign Application Priority Data
Mar. 10, 2017 (CN) 201710142884.8

(51) Int. Cl. G06F 3/042; G06F 3/0481; G06F 3/0488; G06F 3/041

(52) U.S. Cl. CPC G06F 3/0425; G06F 3/0416; G06F 3/04883; G06F 3/04815

(57) ABSTRACT

Disclosed are a 3D (three-dimensional) touch interaction device, a touch interaction method thereof, and a display device. The 3D touch interaction device includes at least one display panel, at least one image acquiring device, at least one distance detector, and a controller. A position of the human hand in a 3D space is acquired through the image acquiring device and the distance detector, and is output to the controller, so as to improve the space positioning precision of the 3D touch interaction device; in this way, the controller can accomplish a touch operation according to the gesture recognized by the image acquiring device upon determining that the 3D coordinate range of the human hand and the 3D coordinate range of the 3D image have an intersection point.

The present application claims priority of China Patent application No. 201710142884.8 filed on Mar. 10, 2017, the content of which is incorporated in its entirety as portion of the present application by reference herein.

### TECHNICAL FIELD

The present disclosure relates to a three dimensional (3D) touch interaction device, a touch interaction method thereof, and a display device.

### BACKGROUND

With the progress of the display technology, naked eye 3D, video player, and virtual reality (VR) technologies become the hot topics in the display application field. 3D stereo display technology is a technology based on plane stereo imaging realized through holographic technology, projecting technology, glasses type technology. The biggest feature that distinguishing it from ordinary display technology is the ability to “reproduce real reproduction”. Based on this display technology, a 3D image with a physical depth of field can be directly seen, and the real 3D stereo display technology has images with verisimilitude and various advantages such as full view, multi-angle, and multi-person observation. If the 3D stereo display technology is combined with remote interaction in space to realize a touch function, the 3D stereo display technology can also bring excellent human-computer interaction experience to the user.

### SUMMARY

Embodiments of the disclosure provides a three dimensional (3D) touch interaction device, comprising: at least one display panel, at least one image acquiring device, at least one distance detector, and a controller, wherein the display panel is configured to display a 3D image; the image acquiring device is configured to acquire a coordinate of a touch body in a two dimensional (2D) plane and output the coordinate to the controller; the distance detector is configured to acquire a distance between the touch body and the display panel in a 3D space and output the distance to the controller; the controller is configured to create a 3D coordinate range of the touch body in the 3D space according to the coordinate of the touch body in the 2D plane and the distance between the touch body and the display panel, and, upon determining that the 3D coordinate range and a 3D coordinate range of the 3D image have an intersection point, performing a touch operation to an image of a region corresponding to the intersection point in the 3D image.

In some examples, the controller is further configured to highlight the image of the region corresponding to the intersection point in the 3D image.

In some examples, the controller is further configured to display an image corresponding to a region with a 2D coordinate coincident with that of the touch body and a 3D coordinate different from that of the touch body in the 3D image in a transparent state or move away the image corresponding to the region with the 2D coordinate coincident with that of the touch body and the 3D coordinate different from that of the touch body in the 3D image from the 2D coordinate.

In some examples, the image acquiring device is further configured to perform an eye tracking detection to determine a position coordinate currently watched by human eyes on the display panel, and output the position coordinate to the controller.

In some examples, the controller is further configured to switch the 3D image currently displayed to a region corresponding to the position coordinate on the display panel for displaying according to the position coordinate.

In some examples, the 3D touch interaction device comprises a plurality of display panels which are located in different directions, and a plurality of image acquiring devices being in one-to-one correspondence with the plurality of display panels; each of the plurality of image acquiring devices is configured to perform an eye tracking detection to determine a position coordinate currently watched by human eyes and output the position coordinate to the controller; and the controller is configured to switch the 3D image currently displayed to one of the plurality of display panels in a direction corresponding to the position coordinate for displaying according to the position coordinate.

In some examples, the distance detector is further configured to feed back a distance between the touch body and the display panel in the 3D space after the touch body being moved to the image acquiring device.

In some examples, the image acquiring device is further configured to focus on the touch body according to the distance and acquire a coordinate position of the touch body in the 2D plane after the touch body being moved.

In some examples, the distance detector comprises an ultrasonic transducer; the ultrasonic transducer is configured to acquire the distance between the touch body and the display panel in the 3D space through an ultrasonic detection.

In some examples, the distance detector at least comprises a group of two ultrasonic transducers which are disposed opposite to each other; one of the ultrasonic transducers is configured to transmit a ultrasonic wave, and the other one of the ultrasonic transducers is configured to receive the ultrasonic wave; or, one of the ultrasonic transducers is configured to transmit a ultrasonic wave, and both of the ultrasonic transducers are configured to receive the ultrasonic wave.

In some examples, the image acquiring device comprises a camera; the camera is configured to acquire the coordinate of the touch body in the 2D plane and generate a corresponding image.

Embodiments of the disclosure provide a touch interaction method of the 3D touch interaction device as mentioned above, comprising: displaying a 3D image; acquiring a coordinate of a touch body in a 2D plane; acquiring a distance between the touch body and the display panel in a 3D space; creating a 3D coordinate range of the touch body in the 3D space according to the coordinate of the touch body in the 2D plane and the distance between the touch body and the display panel, and upon determining the 3D coordinate range and a 3D coordinate range of the 3D image having an intersection point, performing a touch operation on an image of a region corresponding to the intersection point in the 3D image.

In some examples, the touch interaction method further comprises: highlighting the image of the region corresponding to the intersection point in the 3D image.

In some examples, the touch interaction method further comprises: displaying an image corresponding to a region with a 2D coordinate coincident with that of the touch body and a 3D coordinate different from that of the touch body in the 3D image in a transparent state, or, moving away the image corresponding to the region with the 2D coordinate coincident with that of the touch body and the 3D coordinate different from that of the touch body in the 3D image from the 2D coordinate.

In some examples, the touch interaction method further comprises: determining a position coordinate currently watched by human eyes on the display panel through an eye tracking detection; and switching the 3D image currently displayed to a region corresponding to the position coordinate on the display panel for displaying according to the position coordinate.

In some examples, the 3D touch interaction device comprises a plurality of the display panels in different directions and a plurality of image acquiring devices being in one-to-one correspondence with the display panels; the touch interaction method further comprises: determining a position coordinate currently watched by human eyes through eye tracking detection; and switching the 3D image currently displayed to one of the plurality of display panels in a direction corresponding to the position coordinate for displaying according to the position coordinate.

Embodiments of the disclosure provide a display device, comprising the 3D touch interaction device as mentioned above.

In some examples, the display device comprising any one selected from the group consisting of a virtual reality helmet, virtual reality glasses and a video player.

In some examples, the 3D touch interaction device, the touch interaction method thereof, and the display device provided by the embodiments of the present disclosure can realize a remote interaction touch operation of a 3D display device, and improve the experience of human-computer interaction.

### BRIEF DESCRIPTION OF THE DRAWINGS

In order to clearly illustrate the technical solution of embodiments of the present disclosure, the drawings of the embodiments will be briefly described in the following, it is obvious that the drawings in the description are only related to some embodiments of the present disclosure and not limited to the present disclosure.

FIG. 1 is a structural schematic diagram of a 3D touch interaction device provided by an embodiment of the present disclosure;

FIG. 2 is a 3D imaging schematic diagram provided by an embodiment of the present disclosure;

FIG. 3 is a schematic diagram of a touch interaction process of a 3D touch interaction device provided by an embodiment of the present disclosure;

FIG. 4 is a flow diagram of interaction compensation between a camera and an ultrasonic transducer provided by an embodiment of the present disclosure;

FIG. 5 is a schematic diagram of distance detection of an ultrasonic transducer provided by an embodiment of the present disclosure;

FIG. 6 is a schematic diagram of configuration positions of a camera and an ultrasonic transducer provided by an embodiment of the present disclosure;

FIG. 7 is a flow diagram of a touch interaction method of a 3D touch interaction device provided by an embodiment of the present disclosure; and

FIG. 8 is a schematic diagram of a specific touch interaction process of a 3D touch interaction device provided by an embodiment of the present disclosure.

### DETAILED DESCRIPTION

In order to make objects, technical details and advantages of the embodiments of the present disclosure apparently, the technical solutions of the embodiments will be described in a clearly and fully understandable way in connection with the drawings related to the embodiments of the present disclosure. It is obvious that the described embodiments are just a part but not all of the embodiments of the present disclosure. Based on the described embodiments herein, a person having ordinary skill in the art may obtain other embodiment(s), without any inventive work, which should be within the scope of the disclosure.

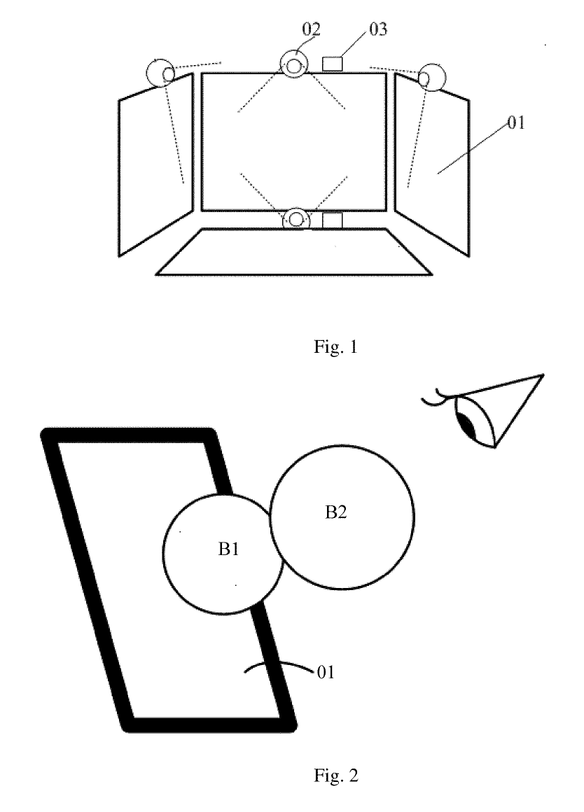

Embodiments of the present disclosure provide a 3D touch interaction device, as illustrated by FIG. 1, including: at least one display panel 01, at least one image acquiring device 02, at least one distance detector 03 and a controller (not shown in FIG. 1).

The display panel 01 is used to display a 3D image; the image acquiring device 02 is used to acquire a coordinate of a touch body in a 2D plane and output the coordinate to the controller; the distance detector 03 is used to acquire a distance between the touch body and the display panel 01 in a 3D space and output the distance to the controller; the controller is used to create a 3D coordinate range of the touch body in the 3D space according to the coordinate of the touch body in the 2D plane and the distance between the touch body and the display panel 01, and, upon determining the 3D coordinate range and the 3D coordinate range of the 3D image have an intersection point, perform a touch operation to an image of a region corresponding to the intersection point in the 3D image.

In the abovementioned 3D touch interaction device provided by the embodiments of the present disclosure, as illustrated by FIG. 2, the display effect of the 3D display image is an effect that object images (B1, B2) seen by human eyes are floating outside the display panel 01 and have a distance feeling. However, regarding to the operations of these objections, besides a 2D plane of up, down, left, and right, a distance between a touch body, for example, a human hand, and the display panel in a third dimension needs to be determined, and only the 3D coordinate of the human hand in the 3D space is determined, a motion of human-computer interaction can be successfully implemented on a 3D virtual image. The present disclosure recognizes a gesture and acquires a position of the human hand in a 3D space through the image acquiring device and the distance detector, and outputs the gesture and position to the controller, so as to improve the space positioning precision of the 3D touch interaction device, and realize a detection of high precision. In this way, the controller can accomplish a touch operation according to the gesture recognized by the image acquiring device upon the 3D coordinate range of the human hand and the 3D coordinate range of the 3D image having an intersection point, i.e., the human hand touches the 3D image, realize a combination of precise space positioning and software control, and provide a visual feedback, which can make the interaction operations more fluent, so as to improve the experience of human-computer interaction.

For example, “2D plane” refers to a plane parallel to the display panel; however, the embodiments of the present disclosure are not limited thereto. In the case that the 3D coordinate of the touch body can be obtained, any other suitable planes can also be selected according to the practical situations. For example, a direction of a distance between the touch body and the display panel is perpendicular to the 2D plane.

For example, in the abovementioned 3D touch interaction device provided by embodiments of the present disclosure, the controller is further used to highlight the image of the region corresponding to the intersection point in the 3D image, and transparently display an image corresponding to a region with a 2D coordinate coincident with that of the touch body and with a 3D coordinate different from that of the touch body in the 3D image. For example, in the abovementioned 3D touch interaction device provided by the embodiments of the present disclosure, in order to make the user clearly know that he has touched a certain object in the 3D image, so as to perform a touch operation on the object and improve the pleasure of the human-computer interaction experience, the controller can compare the coordinate range of the touch body (for example, a human hand) in the 3D space and the 3D coordinate range of an image of the object in the 3D image, upon it being determined that the two coordinate ranges have an intersection point, it shows that the human hand has touched the image of the object of a region corresponding to the intersection point in the 3D image. The controller highlights the image of the object of the region corresponding to the intersection point in the 3D image, such that the operator can know that his hand can already control the object in the virtual space, and perform an operation to the object along with a click or other gestures of the hand. Besides, the image corresponding to a region with a 2D coordinate coincident with that of the touch body and a 3D coordinate different from that of the touch body in the 3D image is displayed in a transparent state, i.e., transparently displaying the image of object which is passed by the human hand, such that a visual feedback can be provided to make the interaction operation more successful. Alternatively, the image of the object which is passed by the human hand can be configured to flick (for example, move away the image corresponding to the region with the 2D coordinate coincident with that of the touch body and the 3D coordinate different from that of the touch body in the 3D image from the 2D coordinate of the human hand), and the specific configuration can be selected according to the practical requirements, which is not limited herein.

For example, in the abovementioned 3D touch interaction device provided by the embodiments of the present disclosure, the image acquiring device is further used to perform an eye tracking detection to determine a position coordinate currently watched by human eyes on the display panel, and output the position coordinate to the controller. The controller is further used to switch the 3D image currently displayed to a region corresponding to the position coordinate on the display panel according to the position coordinate. For example, in the abovementioned 3D touch interaction device provided by the embodiments of the present disclosure, the image acquiring device will utilize the eye tracking detection to detect the position coordinate currently watched by the user, so as to perform an adjustment on the panel imaging, i.e., switching the 3D image to the region corresponding to the position coordinate on the display panel according to the position coordinate, which improves the visual feedback, so as to improve the user experience.

For example, in the abovementioned 3D touch interaction device provided by the embodiments of the present disclosure, as illustrated by FIG. 1, the 3D touch interaction device includes a plurality of display panels 01 which are located in different directions, and a plurality of image acquiring devices 02 being in one-to-one correspondence with the plurality of display panels 01; each of the image acquiring devices 02 is used for eye tracking detection to determine a position coordinate currently watched by human eyes and output the position coordinate to the controller; the controller switches the 3D image currently displayed to one of the plurality of display panels of a corresponding direction of the position coordinate according to the position coordinate.

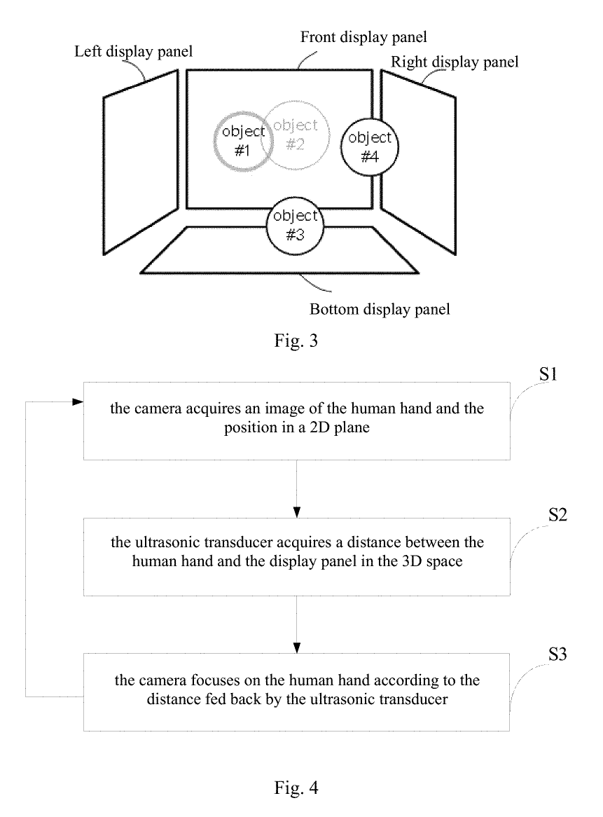

For example, in the abovementioned 3D touch interaction device provided by the embodiments of the present disclosure, as illustrated by FIG. 3, upon facing a front display panel, the user will see the imaging of front objects, such as object #1 and object #2, and the image acquiring device will detect the position watched by the user through an eye tracking detection, and an adjustment of the imaging on the display panel will be performed. Upon the user touching the object #1 with a hand, the image acquiring device and the distance detector will detect a 3D coordinate of the hand of the user; before the hand reaches the target position object #1, the hand will pass through the object #2, the controller will transparently display the object #2, as illustrated by FIG. 3; upon the hand touching the object #1, the controller highlights the object #1, at this time, the user knows that his hand has touched the object, and the user can start to perform an operation of gesture, and the operation of gesture will be detected by the image acquiring device and the distance detector and fed back to the controller, so as to perform 3D image display. Upon the object moving among the display panels, the controller switches the display panels for displaying according to the feedback of the image acquiring device. As illustrated by FIG. 3, during a process that the object #1 moves to a lower position of object #3, or a process that the object #1 moves to a right position of object #4, in order to reduce the visual errors among different display panels, the image acquiring device can be utilized to determine a coordinate position currently watched by the user along with an eye tracking, so as to feed the coordinate position back to the controller to perform a 3D display adjustment. If the eyes watch the front display panel, the front display panel is in charge of displaying the object #4, if the eyes changes to watch the right display panel, then the right display panel is in charge of displaying, and the same mode can be applied to the bottom display panel.

For example, in the abovementioned 3D touch interaction device provided by the embodiments of the present disclosure, the distance detector is used to feed back a distance between the touch body and the display panel in the 3D space after a movement to the image acquiring device, and the image acquiring device is further used to focus the touch body according to the distance, to acquire a coordinate position of the human hand in the 2D plane after the movement. For example, in the abovementioned 3D touch interaction device provided by the embodiments of the present disclosure, during the process of human-computer interaction, with the change (for example, change of gesture of human hand) and position change of the object, the image acquiring device and the distance detector can detect in real time the coordinate position of the touch body of the human hand in the 3D space, at the same time, the distance detector can feed back the distance between the human hand and the display panel to the image acquiring device, in this way. Thus, the image acquiring device can focus on the hand according to the distance, so as to reduce the gesture misjudgment caused by light blocking situations during the hand operation.

To sum up, the image acquiring device and the distance detector can perform interaction compensation, to improve the detection precision of the position of human hand and reduce the errors of gesture recognition. The image acquiring device and the distance detector can respectively realized by a camera and an ultrasonic transducer. An example of a compensation process is illustrated by FIG. 4: S1, the camera acquires an image of the human hand and the position in a 2D plane; S2, the ultrasonic transducer acquires a distance between the human hand and the display panel in the 3D space; S3, the camera focus on the human hand according to the distance fed back by the ultrasonic transducer. After focusing on the human hand, the camera can locate the human hand in the 2D plane again.

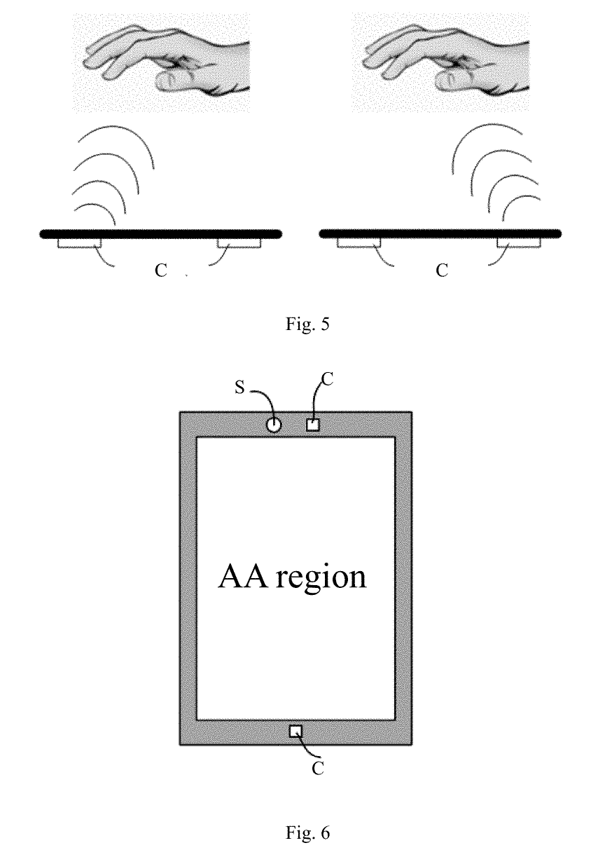

For example, in the abovementioned 3D touch interaction device provided by the embodiments of the present disclosure, as illustrated by FIG. 1, the image acquiring device can be realized through a camera S; the camera S can be used to acquire a coordinate of the touch body, i.e., human hand in 2D plane and generate a corresponding image. The 3D touch interaction device can include: at least one group of two ultrasonic transducers C which are disposed opposite to each other; wherein, one of the ultrasonic transducers C is used to transmit a ultrasonic wave, the other one of the ultrasonic transducers C is used to receive ultrasonic wave; or, one of the ultrasonic transducers C is used to transmit a ultrasonic wave, and both of the ultrasonic transducers C are used to receive ultrasonic wave. For example, upon the 3D touch interaction device being initializing, an object is imaged before the human eyes, the camera will recognize a gesture of the human hand along with an algorithm, and determine a position of the human hand in the 2D plane, i.e., the X/Y plane; and the ultrasonic transducer will detect a distance between the hand and the display panel. For example, after the camera determines a plane position of the human hand, as illustrated by FIG. 5, the ultrasonic transducer will transmit an ultrasonic wave and receive an ultrasonic wave which is reflected back, so as to acquire the distance. The left ultrasonic transducer C may firstly transmit and receive the ultrasonic wave, or the right ultrasonic transducer C transmits or receives the ultrasonic wave; or, one of the left and right ultrasonic transducers C transmits the ultrasonic wave, and both of the left and right ultrasonic transducers receive the ultrasonic wave, so that it is favorable to precisely position the distance between the human hand and the display panel. Furthermore, the controller can determine a 3D coordinate of the human hand in the 3D space, to determine which object the human hand is located, and then perform a touch operation to the object according to the gesture recognized by the camera.

It is to be noted that, in the abovementioned 3D touch interaction device provided by the embodiments of the present disclosure, as illustrated by FIG. 6, a camera S and an ultrasonic transducer C can be disposed in an un-viewable region of the display panel (for example, a frame region, a flexible circuit board PCB, or FPC of the display panel), the camera and ultrasonic transducer are not limited to the positions marked in FIG. 6, and the number of each of them are not limited to one or more.

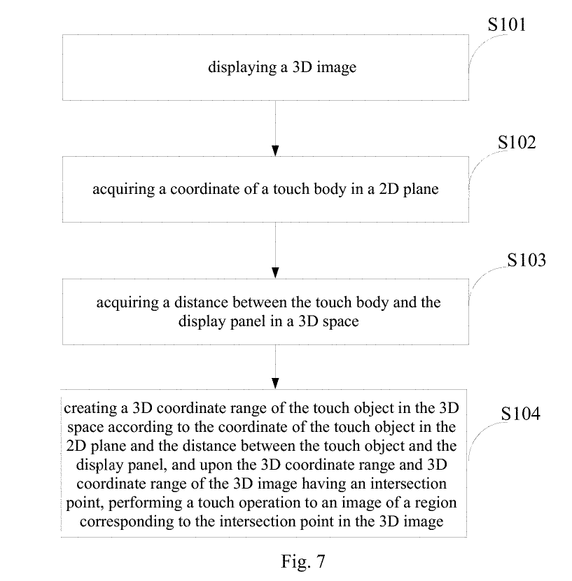

Based on the same invention concept, the embodiments of the present disclosure provide a touch interaction method of the abovementioned 3D touch interaction device provided by the embodiments of the present disclosure, as illustrated by FIG. 7, including the following steps S101-S104.

S101: displaying a 3D image;

S102: acquiring a coordinate of a touch body in a 2D plane;

S103: acquiring a distance between the touch body and the display panel in a 3D space;

S104: creating a 3D coordinate range of the touch body in the 3D space according to the coordinate of the touch body in the 2D plane and the distance between the touch body and the display panel, and upon the 3D coordinate range and 3D coordinate range of the 3D image having an intersection point, performing a touch operation to an image of a region corresponding to the intersection point in the 3D image.

In the abovementioned touch interaction method provided by the embodiments of the present disclosure, by acquiring a position of the touch body, i.e., the human hand in the 3D space, the space positioning precision of the 3D touch interaction device can be improved; in this way, upon it being determined that the 3D coordinate range of the human hand and the 3D coordinate range of the 3D image having an intersection point, a corresponding touch operation can be accomplished according to the recognized gesture, so as to realize a combination of precise space positioning and software control and provide a visual feedback, which makes the interaction operation more fluent, so as to improve the experience of 3D display human-computer interaction.

For example, in the abovementioned touch interaction method provided by the embodiments of the present disclosure, the method may further include: highlighting the image of the region corresponding to the intersection point in the 3D image; and transparently displaying an image corresponding to a region with a 2D coordinate coincident with that of the touch body and a 3D coordinate different from that of the touch body in the 3D image. For example, in order to make the user clearly know that he has touched a certain object in the 3D image, so as to perform a touch operation on the object and improve the pleasure of the human-computer interaction experience, the coordinate range of the touch body (for example, a human hand) in the 3D space and the 3D coordinate range of an image of the object in the 3D image can be compared, upon it being determined that the two coordinate ranges have an intersection point, it shows that the human hand has touched the image of the object. Then the image of the object is highlighted, such that the operator can know that his hand can already control the object in the virtual space, and perform an operation on the object along with a click or other gestures of the hand. Besides, the image corresponding to the region with the 2D coordinate coincide with that of the touch body and the 3D coordinate different from that of the touch body in the 3D image is transparently displayed, such that a visual feedback can be provided to make the interaction operation more successful.

For example, in the abovementioned touch interaction method provided by the embodiments of the present disclosure, the method may further include: determining a position coordinate currently watched by human eyes on the display panel through an eye tracking detection; and switching the 3D image currently displayed to a region corresponding to the position coordinate on the display panel for displaying according to the position coordinate. Alternatively, the 3D touch interaction device may be provided with a plurality of the display panels in different directions and a plurality of image acquiring devices being in one-to-one correspondence with the display panels; the touch interaction method further includes: determining a position coordinate currently watched by human eyes through an eye tracking detection; and switching the 3D image currently displayed to one of the plurality of display panels of a corresponding direction of the position coordinate according to the position coordinate. For example, a position coordinate currently watched by the user is acquired by utilizing the eye tracking detection, so as to perform an adjustment of imaging on the display panel, i.e., switching the 3D image to the region corresponding to the position coordinate on the display panel for displaying, or switching the 3D image to one of the plurality of display panels which is currently watched by the eyes for displaying, so as to improve the visual feedback and improve the user experience.

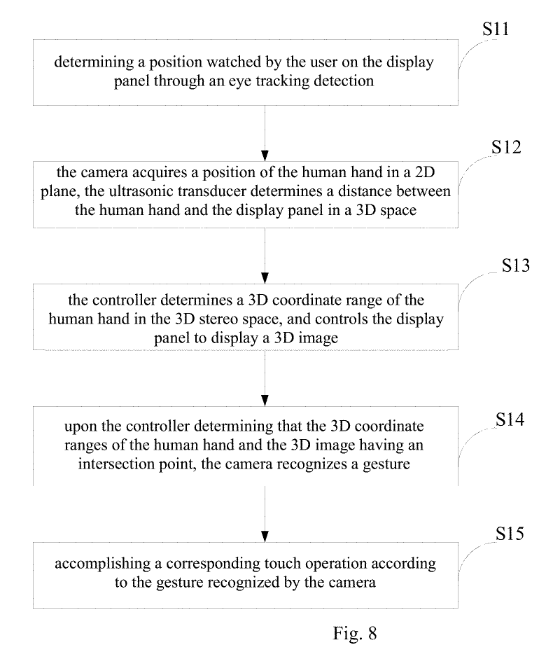

Hereinafter, an example will be described to illustrate a touch interaction process of the abovementioned 3D touch interaction device provided by the embodiments of the present disclosure. For example, as illustrated by FIG. 8, the touch interaction process includes the following steps S11-S15.

S11, determining a position watched by the user on the display panel through an eye tracking detection;

S12, acquiring a position of the human hand in a 2D plane by the camera, determining a distance between the human hand and the display panel in a 3D space by the ultrasonic transducer;

S13, determining a 3D coordinate range of the human hand in the 3D space, and controls the display panel to display a 3D image by the controller;

S14, upon the controller determining that the 3D coordinate ranges of the human hand and the 3D image having an intersection point, recognizing a gesture by the camera;

S15, accomplishing a corresponding touch operation according to the gesture recognized by the camera.

In the following processes, the position of the human hand in the 3D space is continuously and repeatedly determined, and the gesture is recognized for accomplishing the corresponding touch operation, until the user gives an end instruction. During the process, the eye tracking detection detects the position watched by human eyes in real-time, so as to assistant the controller to realize switching among the display panels.

Based on the same invention concept, the embodiments of the present disclosure provide a display device, including the abovementioned 3D touch interaction device provided by the embodiments of the present disclosure. The display device can be any one selected from the group consisting of virtual reality helmet, virtual reality glasses and video player. Certainly, the 3D touch interaction device can be applied to other display devices, which is not limited thereto. Because the principle that the display device solves the problem is similar to that of the 3D touch interaction device, thus, the implementations of the display device can refer to the implementations of the 3D touch interaction device, and the repeated portions are omitted herein.

The embodiments of the present disclosure provide a 3D touch interaction device, a touch interaction method thereof, and a display device. The 3D touch interaction device includes: at least one display panel, at least one image acquiring device, at least one distance detector, and a controller; the display panel is used to display a 3D image; the image acquiring device is used to acquire a coordinate of a touch body in a 2D plane and output the coordinate to the controller; the distance detector is used to acquire a distance between the touch body and the display panel in a 3D space and output the distance to the controller; the controller is used to create a 3D coordinate range of the touch body in the 3D space according to the coordinate of the touch body in the 2D plane and the distance between the touch body and the display panel, and, upon determining the 3D coordinate range and the 3D coordinate range of the 3D image having an intersection point, performing a touch operation on an image of a region corresponding to the intersection point in the 3D image. In this way, by the image acquiring device and the distance detector, the position of the touch body, for example, a human hand, in the 3D space can be obtained and outputted to the controller, so as to improve the space positioning precision of the 3D touch interaction device; furthermore, upon determining that the 3D coordinate range of the human hand and the 3D coordinate range of the 3D image have an intersection point, i.e., the human hand touches the 3D image, the controller accomplishes the corresponding touch operation according to the gesture recognized by the image acquiring device, so as to realize a combination of precise space positioning and software control, which provides a visual feedback and makes the interaction operation more fluent, so as to improve the experience of 3D display human-computer interaction.

In the embodiments of the present disclosure, the controller can be realized through software, so as to be conveniently executed by various processors. For example, a marked executable code module may include one or more physical or logic block of a computer instruction, for example, which can be constructed as an object, an process, or a function. In spite of this, it is not necessary for the executable codes to be physically located together, the executable codes can include different instructions stored in different physical memories, upon these instructions are logically combined together, they can constitute the controller and realize the assigned purposes of the controller.

In fact, the executable code module can be a single instruction or a plurality of instructions, which can even be distributed in different code segments, distributed in different programs, and distributed across multiple memories. Likewise, the operated data can be recognized in the module, and realized in any suitable formats, organized in any suitable types of data structure. The operated data can be collected as a signal data, or distributed in different positions (including in different storage devices), and at least partially existing in the system or network as electronic signals.

Upon the controller being able to be realized through software, in consideration of the technical level of the existing hardware, thus, the modules can be realized through software. Without considering the costs, those skilled in the related art can build a corresponding hardware circuit to realize the corresponding functions, and the hardware circuit includes a very large scale integrated (VLSI) circuit, a gate array, a semiconductor device such as a logical chip, a transistor, or other divided elements. The modules can also be realized by a programmable hardware device, such as a field-programmable gate array (FPGA), or a programmable array logical or programmable logical device.

The foregoing is only the preferred embodiments of the present invention and not intended to limit the scope of protection of the present invention. The scope of protection of the present invention should be defined by the appended claims.

1. A three dimensional (3D) touch interaction device, comprising: at least one display panel, at least one image acquiring device, at least one distance detector, and a controller, wherein
the display panel is configured to display a 3D image;
the image acquiring device is configured to acquire a coordinate of a touch body in a two dimensional (2D) plane and output the coordinate to the controller;
the distance detector is configured to acquire a distance between the touch body and the display panel in a 3D space and output the distance to the controller;
the controller is configured to create a 3D coordinate range of the touch body in the 3D space according to the coordinate of the touch body in the 2D plane and the distance between the touch body and the display panel, and, upon determining that the 3D coordinate range of the touch body and a 3D coordinate range of the 3D image have an intersection point, performing a touch operation to an image of a region corresponding to the intersection point in the 3D image,
wherein the controller is further configured to display an image corresponding to a region with a 2D coordinate coincident with that of the touch body and a 3D coordinate different from that of the touch body in the 3D image in a transparent state or move away the image corresponding to the region with the 2D coordinate coincident with that of the touch body and the 3D coordinate, different from that of the touch body in the 3D image from the 2D coordinate.

2. The 3D touch interaction device according to claim 1, wherein the controller is further configured to highlight the image of the region corresponding to the intersection point in the 3D image.

3. (canceled)

4. The 3D touch interaction device according to claim 1, wherein the image acquiring device is further configured to perform an eye tracking detection to determine a position coordinate currently watched by human eyes on the display panel, and output the position coordinate to the controller.

5. The 3D touch interaction device according to claim 4, wherein the controller is further configured to switch the 3D image currently displayed to a region corresponding to the position coordinate on the display panel for displaying according to the position coordinate.

6. The 3D touch interaction device according to claim 1, wherein the 3D touch interaction device comprises a plurality of display panels which are located in different directions, and a plurality of image acquiring devices being in one-to-one correspondence with the plurality of display panels;
each of the plurality of image acquiring devices is configured to perform an eye tracking detection to determine a position coordinate currently watched by human eyes and output the position coordinate to the controller; and
the controller is configured to switch the 3D image currently displayed to one of the plurality of display panels in a direction corresponding to the position coordinate for displaying according to the position coordinate.

7. The 3D touch interaction device according to claim 1, wherein the distance detector is further configured to feed back a distance between the touch body and the display panel in the 3D space after the touch body being moved to the image acquiring device.

8. The 3D touch interaction device according to claim 7, wherein the image acquiring device is further configured to focus on the touch body according to the distance fed back by the distance detector after the touch body being moved and acquire a coordinate position of the touch body in the 2D plane after the touch body being moved.

9. The 3D touch interaction device according to claim 8, wherein the distance detector comprises an ultrasonic transducer; the ultrasonic transducer is configured to acquire the distance between the touch body and the display panel in the 3D space through a ultrasonic detection.

10. The 3D touch interaction device according to claim 9, wherein the distance detector at least comprises a group of two ultrasonic transducers which are disposed opposite to each other;
one of the ultrasonic transducers is configured to transmit an ultrasonic wave, and the other one of the ultrasonic transducers is configured to receive the ultrasonic wave; or, one of the ultrasonic transducers is configured to transmit a ultrasonic wave, and both of the ultrasonic transducers are configured to receive the ultrasonic wave.

11. The 3D touch interaction device according to claim 1, wherein the image acquiring device comprises a camera; the camera is configured to acquire the coordinate of the touch body in the 2D plane and generate a corresponding image.

12. A touch interaction method of the 3D touch interaction device according to claim 1, comprising:
displaying a 3D image;
acquiring a coordinate of a touch body in a 2D plane;
acquiring a distance between the touch body and the display panel in a 3D space;
creating a 3D coordinate range of the touch body in the 3D space according to the coordinate of the touch body in the 2D plane and the distance between the touch body and the display panel, and upon determining the 3D coordinate range of the touch body and a 3D coordinate range of the 3D image having an intersection point, performing a touch operation on an image of a region corresponding to the intersection point in the 3D image; and
displaying an image corresponding to a region with a 2D coordinate coincident with that of the tough body and a 3D coordinate different from that of the touch body in the 3D image in a transparent state, or moving away the image corresponding to the region with the 2D coordinate coincident with that of the touch, body and the 3D coordinate different from that of the touch body in the 3D image, from the 2D coordinate.

13. The touch interaction method according to claim 12, further comprising:
highlighting the image of the region corresponding to the intersection point in the 3D image.

14. (canceled)

15. The touch interaction method according to claim 12, further comprising:
determining a position coordinate currently watched by human eyes on the display panel through an eye tracking detection; and
switching the 3D image currently displayed to a region corresponding to the position coordinate on the display panel for displaying according to the position coordinate.

16. The touch interaction method according to 12, wherein the 3D touch interaction device comprises a plurality of the display panels in different directions and a plurality of image acquiring devices being in one-to-one correspondence with the display panels; the touch interaction method further comprises:
determining a position coordinate currently watched by human eyes through eye tracking detection; and
switching the 3D image currently displayed to one of the plurality of display panels in a direction corresponding to the position coordinate for displaying according to the position coordinate.

17. A display device, comprising the 3D touch interaction device according to claim 1.

18. The display according to claim 17, wherein the display device comprising any one selected from the group consisting of a virtual reality helmet, virtual reality glasses and a video player.
